(19) United States
(12) Patent Application Publication
(10) Pub. No.: US 2025/0371310 A1
(43) Pub. Date: Dec. 4, 2025

(54) TRAINING PREDICTIVE MODELS BASED ON REWARD SIGNALS

(71) Applicant: INTUIT INC., Mountain View, CA (US)

(72) Inventors: Nan JIANG, Mountain View, CA (US); Zhao HU, Fremont, CA (US); Aakanksha SAH, Thousand Oaks, CA (US); Piyush CHOUDHARY, San Jose, CA (US); Yashwanth MUSIBOYINA, San Jose, CA (US); Divya BEERAM, Fremont, CA (US); Siwei (Stephen) YU, Ontario (CA)

(21) Appl. No.: 18/680,823

(22) Filed: May 31, 2024

(51) Int. Cl. G06N 3/0442

(52) U.S. Cl. CPC G06N 3/0442

(57) ABSTRACT

Aspects of the present disclosure provide techniques for training and using machine learning models to predict and present an optimal workflow to a user of a software application. An example method generally includes generating a plurality of sequences for a workflow, the workflow including a plurality of steps. Each respective sequence of the plurality of sequences for the workflow is deployed to a respective set of test users. A reward metric is calculated for each respective sequence based on a performance metric for users who complete the workflow and a performance metric for users who abandon the workflow or have not executed the workflow. A machine learning model is trained, based on a training data set including the plurality of sequences and the reward metric for each respective sequence, to predict an optimal workflow for a user. Generally, the machine learning model may be trained to optimize the reward metric.

Aspects of the present disclosure relate to machine learning models.

### BACKGROUND

Software applications can be consumed on a variety of devices, including desktop computers, laptops, tablets, smartphones, and the like. These applications may be native applications (e.g., applications for which an executable file is built specifically for that platform), web components hosted in a native application, or web applications in which data provided by a user is processed remotely. Generally, these applications implement various workflows which can be decomposed into a plurality of mini jobs (also referred to as workflow steps, sub-workflows, etc.) which can be shown in an arbitrary order. As the number of mini jobs included in a workflow increases, the number of sequences in which these mini jobs can be displayed to a user of the software application may correspondingly increase. For example, for a workflow including three mini jobs, there are six possible sequences; for a workflow including four mini jobs, there are ten possible sequences; for a workflow including five mini jobs, there are fifteen possible sequences.

Different users of the software application may respond differently to different sequences of mini jobs in a workflow. For example, users with certain characteristics or associated with an entity with certain characteristics may respond differently to one sequence of mini jobs than to another sequence of mini jobs (e.g., may complete a workflow if a first sequence of mini jobs is presented to the user but may not complete the workflow if a second sequence of mini jobs is presented to the user).

Accordingly, techniques for presenting effective workflow sequences to a user of a software application are needed.

### BRIEF SUMMARY

Certain embodiments provide a computer-implemented method for training predictive models to predict and present an optimal workflow to a user of a software application. An example method generally includes generating a plurality of sequences for a workflow, the workflow including a plurality of steps. Each respective sequence of the plurality of sequences for the workflow is deployed to a respective set of test users. A reward metric is calculated for each respective sequence based on a performance metric for users who complete the workflow and a performance metric for users who abandon the workflow or have not executed the workflow. A machine learning model is trained, based on a training data set including the plurality of sequences and the reward metric for each respective sequence, to predict an optimal workflow for a user. Generally, the machine learning model may be trained to optimize the reward metric.

Certain embodiments provide a computer-implemented method for using a predictive model to predict and present an optimal workflow to a user of a software application. An example method generally includes receiving, from a user of a software application, a request to execute a workflow in the software application. Using a predictive model and features associated with the user of the software application, a workflow sequence that maximizes a reward metric for the user of the software application is generated. The generated workflow sequence is executed.

Other embodiments provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example computing environment in which predictive machine learning models are trained and used to predict optimal workflows to present to users of a software application based on a reward metric, according to embodiments of the present disclosure.

FIG. 2 illustrates example operations for training machine learning models to predict optimal workflows to present to users of a software application based on a reward metric, according to embodiments of the present disclosure.

FIG. 3 illustrates example operations for deploying a workflow sequence to a user of a software application using a machine learning model trained to predict an optimal workflow for the user of the software application, according to embodiments of the present disclosure.

FIG. 4 illustrates an example system on which embodiments of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

As discussed, software applications may implement workflows as a series of mini jobs that can be presented to a user of these software applications in order to allow the user to perform the workflow. In many cases, these workflows may be order-invariant or at least partially order-invariant, such that a user may perform any sequence of mini jobs in order to complete the workflow. However, different users may react differently to different sequences of mini jobs. For example, when a user is using a software application for the first time, the wide range of features and presented recommendations may not be conducive to allowing the user to use the software application efficiently and effectively. Further, in many cases, the software application may not have sufficient information from historical user activity to effectively customize the application or the order in which workflow sequences are presented to the user such that the user can efficiently and effectively use the software application.

Because the software application may not have sufficient information to allow for customization of the user experience and the order in which the mini jobs of a workflow are presented to the user, the software application may present workflows to a user of the software application according to an a priori defined sequence of mini jobs or to a randomly selected sequence of mini jobs. In doing so, the software application may not effectively present a workflow to a user of the software application that would address the user's preferences and thus allow the user to efficiently and effectively use the software application. Further, many machine learning models that are used in software applications to customize the behavior of these software applications are descriptive models that predict future behavior. While predicting future behavior may be useful in various tasks such as fraud detection, autocompletion, or the like, these descriptive models generally result in the execution of reactive actions that address what has previously occurred as opposed to proactive actions that potentially have an effect on future outcomes.

Embodiments of the present disclosure provide techniques for training and using machine learning models to predict sequences of workflows in a software application that are likely to allow a user of the software application to efficiently and effectively use the software application. As discussed in further detail herein, a reward metric may be defined for use in optimizing the workflow presented to the user of the software application. This reward metric may, for example, be based on a difference between a value of a parameter for users who have not completed the workflow and a value of the parameter for users who have completed the workflow, such that the reward metric serves as a proxy for some underlying or corresponding metric. To train the machine learning model, sequences of mini jobs of a workflow may be randomly presented to users to gather training data used to train the machine learning model (e.g., to identify a workflow sequence for a given user's attributes that maximizes the reward metric for the user). After a sufficient number of samples have been gathered for the training data set, the machine learning model may be trained to generate a workflow sequence that, as discussed, maximizes the reward metric for the user, and the trained machine learning model may be deployed for use within the application. By doing so, aspects of the present disclosure may dynamically generate workflow sequences for different users of the software application based on user-specific prioritization of different mini jobs within the workflow, which, as discussed, generally allows for the generation and presentation of user interfaces and workflow steps that are likely to result in the user being able to effective and efficiently use the software application. Thus, aspects of the present disclosure may reduce the number of requests for new user interfaces generated by a user of the software application resulting from, for example, the user of a software application hunting for a feature, which may reduce the amount of computing resources (e.g., messaging bandwidth, power, etc.) consumed in rendering user interfaces and displaying information in a software application relevant to a specific user of the software application. Still further, aspects of the present disclosure may allow for relevant portions of a workflow to be proactively presented to a user of a software application, which may reduce the amount of user navigation through different portions of a workflow and also reduce the amount of computing resources (e.g., messaging bandwidth, power, etc.) consumed in rendering user interfaces and displaying information in a software application relevant to a specific user of the software application.

### Example Generating Workflow Sequences in Software Applications Using Machine Learning Models

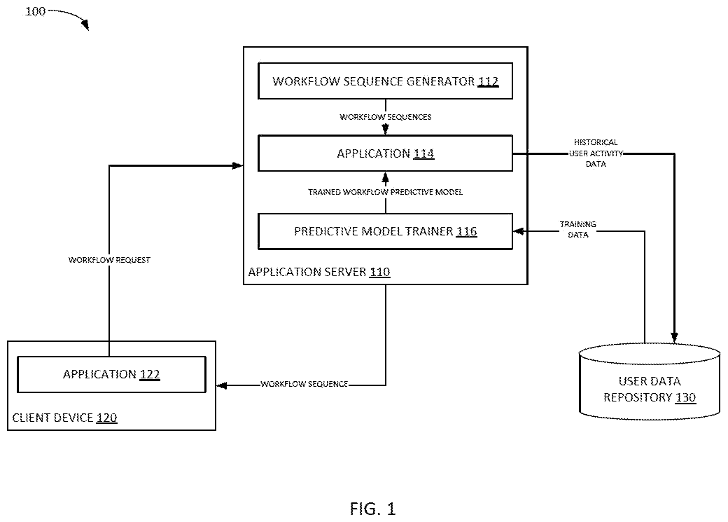

FIG. 1 illustrates an example computing environment 100 in which machine learning models are trained and used to identify an optimal workflow for a user of a software application based on maximization of a reward metric, according to aspects of the present disclosure. As illustrated, computing environment 100 includes an application server 110, a client device 120, and a user data repository 130.

Application server 110 is generally representative of a computing system, such as a server, a cloud compute instance, or the like, which can train a machine learning model and hosts a software application including the machine learning model that may be accessed by users of a client device 120 in the computing environment 100. As illustrated, application server 110 includes a workflow sequence generator 112, an application 114, and a predictive model trainer 116.

Generally, the workflow sequence generator 112 allows for the creation of a training data set by generating random sequences of workflow sequences for users of the application 114 to use to complete a workflow during an initial stage of deployment of the application 114 on the application server 110. In some aspects, the workflow sequence generator 112 can associate each variation of a workflow sequence (e.g., each unique ordering of mini jobs in a workflow) with a unique workflow sequence index and randomly select a workflow sequence index to present to a user of the application 114. In some aspects, the workflow sequence generator 112 can randomly generate a sequence by randomly selecting mini jobs to include in a sequence. Random selection of a sequence by the workflow sequence generator 112 may continue until a machine learning model that predicts an optimal sequence for a user of the application 114 is trained, or until a threshold number of samples is acquired (e.g., at least x samples per unique sequence of mini jobs).

After the workflow sequence generator 112 generates a workflow sequence for a user of the software application, the workflow sequence generator 112 outputs information identifying the generated sequence to the application 114. The application 114 outputs the workflow sequence to the application 122 executing on the client device 120. In response, the application 114 receives user-provided data and other interaction data which can be committed to the user data repository 130 and used to train one or more machine learning models (also referred to as predictive models) to predict an optimal workflow for a user of the application 114 based on maximization (or conversely, minimization) of a reward metric defined for the application 114 or the workflow thereof.

During execution of the application 114, a reward metric may be monitored for each user who has been presented a workflow sequence for execution. Generally, the reward metric may be linked to a metric measured for users who have completed the workflow sequence and a corresponding metric for users who have not completed the workflow sequence. In some aspects, the reward metric may be an a priori defined value ri for each action in a set of actions associated with the workflow sequence, such that completion of a mini job in a workflow sequence is associated with a reward metric of ri=N, N∈R, and non-completion of the mini job in the workflow sequence is associated with a reward metric of ri=0. In some aspects, the reward metric may differ for each mini job in a workflow sequence, with some mini jobs in a workflow sequence (e.g., mini jobs associated with high user retention or a demonstrated history of being associated with user value, mini jobs that are not commonly completed by users of the software application or show a significant difference in performance between users who have completed a mini job and users who have not completed a mini job) being assigned higher values than other mini jobs (e.g., mini jobs that are commonly completed by users of the software application). In another example, consider an accountancy application in which users have the ability to classify or otherwise assign categories to transactions recorded in an accountancy ledger. A reward metric may be based, for example, on revenue or profitability metrics for users who have completed a transaction categorization workflow for one or more transactions recorded in the application and revenue or profitability metrics for users who have not completed a transaction categorization workflow for any transaction recorded in the application. It should be recognized that the foregoing are merely examples of reward metrics which can be monitored and logged in order to train and/or refine a predictive model, and the use and logging of other reward metrics for generating a training data set for a predictive model may be contemplated.

As users execute workflows, the application 114 can log historical user activity data and other user data and commit the user data to the user data repository 130 for the predictive model trainer 116 to use in training a machine learning model to predict an optimal workflow for other users of the application 114. Generally, after the initial data acquisition process is completed (e.g., to generate a training data set used to train the machine learning model), a total number of samples Nₛ may be recorded across the N variants of the workflow. Each workflow variant may be presented 1/Nₛ times during the initial data acquisition process. By randomly generating and presenting workflow variants to users of the application 114, the workflow sequence generator 112 and the application 114 can ensure that a sufficiently large training data set is available for the predictive model trainer 116 to train a predictive model.

In some aspects, the training data set generated based on the logged historical user activity data and other user data committed to the user data repository 130 may be a series of n-tuples including a set of features associated with a user of the application 114, information identifying the workflow sequence presented to the user, information identifying the actions performed by the user, and a reward metric associated with the actions performed by the user. Generally, the features associated with the user of the application may include features which are relevant to a specific workflow and which are available in the user data repository 130 (or other data repositories) to include in an n-tuple. The features may include static features, such as user profile information that is fixed a priori, and dynamic features, such as user activity within the application 114 (e.g., clickstream data, search history, other time-series data describing how the user has previously used the application, etc.). In an accountancy application, for example, the features associated with the user of the application 114 may include static features such as information identifying the industry classification for the user's organization, organization size features (e.g., number of employees, revenue or profit metrics, etc.), age data, and/or the like, and/or dynamic features (e.g., user activity data, as discussed above).

The predictive model trainer 116 uses the historical user activity data committed to the user data repository 130 to train a predictive model that allows the workflow sequence generator 112 and/or application 114 to proactively predict an optimal workflow for a user of the software application. As discussed, an optimal workflow for a user of a software application may be a workflow that results in the maximization, or at least optimization, of a reward metric, where the reward metric serves as a proxy metric that measures (or at least indicates) a likelihood that the user will be able to use the application 114 efficiently and effectively when presented with a given workflow sequence.

Generally, the predictive model trainer 116 can train the predictive model as a causal model that ingests the user features and variants of workflow sequences and outputs information identifying the workflow sequence the optimizes the reward metric. Generally, the optimization of the reward metric may be an optimization of the sum of a reward derived from each mini job (also referred to as an “action”) performed by the user of the application 114, assuming that the user performs each action in the identified workflow sequence.

In some aspects, the predictive model trainer 116 can train the machine learning model using uplift modeling techniques. By using uplift modeling techniques, aspects of the present disclosure can model the increment impact of each action performed by a user of the application 114. To train the machine learning model using uplift modeling techniques, the model may be trained as a single-learner uplift model so that the training data set generated by the application 114 is not split, causing model accuracy to decrease due to data scarcity. The learner used in the sing-learner uplift model may be a tree-based model, such as a gradient boosting tree or the like, which results in a model that maps user features and a variant of a workflow step to a total predicted reward. In other aspects, the predictive model trainer 116 can train the machine learning model as a long-short term memory (LSTM) model that account for timing relationships between actions performed within the application 114, deep learning models, ensemble models, or other machine learning models that can predict an optimal workflow sequence for the user of the application 114 (e.g., the workflow sequence that results in the highest expected total reward, assuming user completion of each action or mini job within the workflow sequence).

The predictive model trainer 116 can deploy the trained machine learning model to the workflow sequence generator 112 and/or the application 114 for subsequent workflow sequence generation for users of the application 114. When a user uses the application 114 (or specific portions thereof), the workflow sequence generator 112 and/or application 114 can use the machine learning model to generate a workflow sequence that maximizes the user's reward metric, assuming the completion of each action or mini job within the workflow sequence (though not necessarily in order of completion). That is, the trained machine learning model may model an outcome (e.g., the total reward metric generated by performing each action within a given workflow sequence) as a function of user features and a workflow sequence. The model may seek the variant of the workflow sequence that maximizes the outcome (e.g., the total reward metric) and return the variant of the workflow sequence that maximizes the outcome.

The machine learning models trained by the predictive model trainer 116 and deployed to one or both of the workflow sequence generator 112 and/or the application 114 for workflow sequence generation may be used in a variety of points within the application 114. In one example, the machine learning model(s) trained by the predictive model trainer 116 can be used when a new user begins using the application 114. After the user has provided some basic user information (which can be used as feature inputs into the machine learning model), the machine learning model can predict which variant of an initial attachment or enrolment workflow that results in the maximization of a reward metric (or is likely to maximize the reward metric). The identified variant of the attachment or enrolment workflow sequence may be executed by one or both of the application 114 and/or the application 120 executing on the client device 120 (which is representative of a variety of client devices which can access an application 114 executing on a remote server, such as a smartphone, a tablet computer, a desktop computer, or the like). In another example, the machine learning models trained by the predictive model trainer 116 may be used when a user begins using a new portion of the application or otherwise uses features that the user has not used before and/or which may be new to the user (e.g., in a more fully featured version of the application 114 to which the user may have upgraded).

### Example Methods for Training Machine Learning Models to Predict Optimal Workflow Sequences in Software Applications

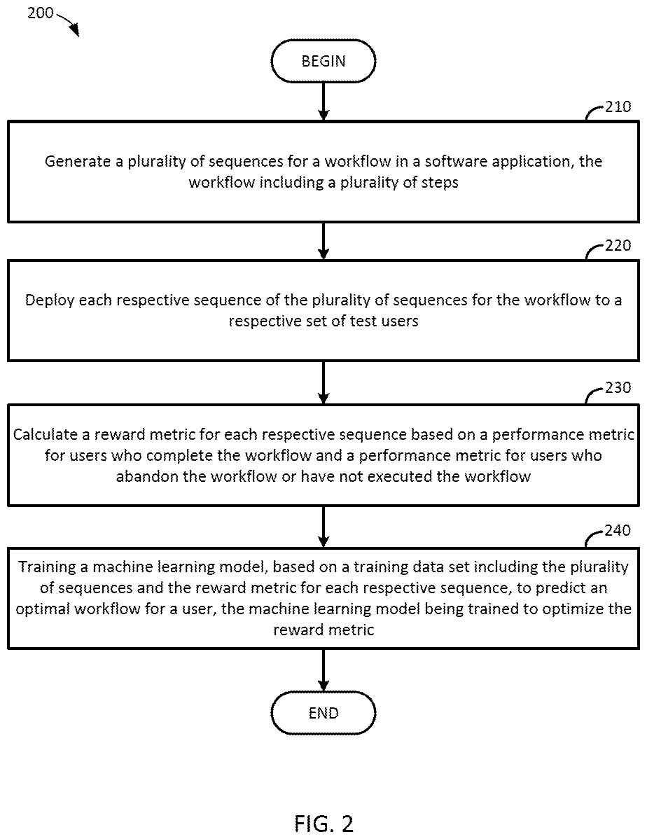

FIG. 2 illustrates example operations 200 that may be performed to train machine learning models to predict optimal workflows to present to users of a software application based on a reward metric, according to embodiments of the present disclosure. Operations 200 may be performed by any computing device which can train and use one or more machine learning models to predict an optimal workflow for a user of a software application based on a training data set of captured user data, such as the application server 110 illustrated in FIG. 1.

As illustrated, operations 200 begin at block 210 with generating a plurality of sequences for a workflow, the workflow including a plurality of steps.

In some aspects, the plurality of sequences for the workflow include a statically defined baseline sequence for the workflow. The plurality of sequences for the workflow may include one or more additional randomly generated sequences for the workflow. Generally, the number of sequences in the plurality of sequences may be equal to the maximum number of possible sequences that can be generated from a workflow including N mini jobs (or actions) that can be independently executed. Generally, the total number of sequences may be represented as the sum of the sequence from N to 1.

In some aspects, generating the plurality of sequences for the workflow comprises generating one or more sequences including a set of steps including a number of steps less than a number of steps in the plurality of steps.

At block 220, operations 200 proceed with deploying each respective sequence of the plurality of sequences for the workflow to a respective set of test users.

In some aspects, a number of users in the respective set of test users is based on a number of sequences in the plurality of sequences and a total number of test users participating in testing the workflow. That is, for a workflow including N mini jobs, and assuming that no mini jobs are omitted, there are

$$\frac{N}{2} ( 1 + N )$$

possible combinations of mini jobs (or workflow sequences), and the number of test users U in any set of test users associated with a specific variant of a workflow may be equal to

$$\frac{1}{U} * \frac{N}{2} ( 1 + N ) .$$

At block 230, operations 200 proceed with calculating a reward metric for each respective sequence based on a performance metric for users who complete the workflow and a performance metric for users who abandon the workflow or have not executed the workflow.

In some aspects, calculating the reward metric comprises calculating a revenue difference between the users who complete the workflow and the users who abandon the workflow or have not executed the workflow.

In some aspects, calculating the reward metric comprises calculating a difference between a performance metric for users who complete the workflow and a performance metric for users who abandon the workflow or have not executed the workflow. The performance metric may, for example, be associated with an a priori defined performance metric for each mini job, step, or other portion of a workflow sequence, where completion of a particular mini job within a workflow adds the associated performance metric to the accumulated reward metric for the user and non-completion of a mini job within the workflow has no impact on the accumulated reward metric for the user.

In some aspects, calculating the reward metric comprises calculating a cumulative reward metric for a user over multiple instances of executing the workflow.

In some aspects, calculating the reward metric comprises calculating a metric based on a number of times a user completed the workflow. The reward metric may, in some aspects, be calculated based on an a priori defined value associated with completing the workflow.

At block 240, operations 200 proceed with training a machine learning model, based on a training data set including the plurality of sequences and the reward metric for each respective sequence, to predict an optimal workflow for a user, the machine learning model being trained to optimize the reward metric.

In some aspects, the training data set further includes one or more features associated with each user of the workflow. These features may include static features associated with each user of the workflow and dynamic features associated with each user of the workflow. The static features may include, for example, features derived from a priori defined data associated with the user, such the size and age of an organization with which the user is associated, The dynamic features may include, for example, time-series data associated with user activity within the application, such as a search history, clickstream history, or the like.

### Example Methods for Deploying Optimal Workflow Sequences in Software Applications Using Machine Learning Models

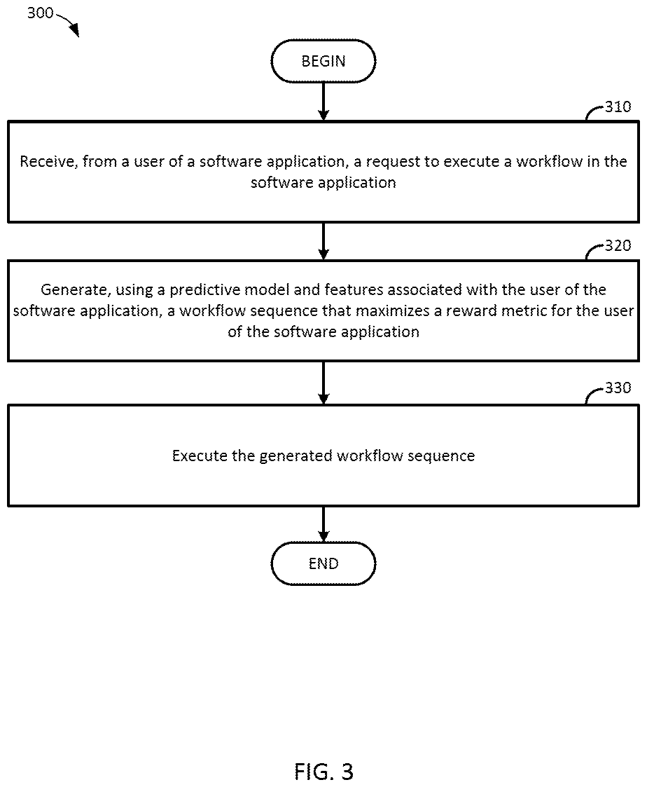

FIG. 3 illustrates example operations 300 for deploying a workflow sequence to a user of a software application using a machine learning model trained to predict an optimal workflow for the user of the software application, according to embodiments of the present disclosure. Operations 300 may be performed by any computing device which can use one or more machine learning models to predict an optimal workflow for a user of a software application based on a training data set of captured user data, such as the application server 110 illustrated in FIG. 1.

As illustrated, operations 300 begin at block 310, with receiving, from a user of a software application, a request to initiate a workflow in the software application.

In some aspects, the request to initiate the workflow in the software application may be received implicitly as part of an initialization process for the user in the software application. The initialization process for the user may, for example, be a process that is executed when the user uses the application for the first time. In another example, the initialization process may be a process that is executed when the user uses a feature within the software application for the first time.

In some aspects, the request to initiate the workflow in the software application may be an explicit request to execute a specific workflow in the software application.

At block 320, the operations 300 proceed with generating, using a predictive model and features associated with the user of the software application, a workflow sequence that maximizes a reward metric for the user of the software application.

In some aspects, the predictive model may be a machine learning model trained to output a predicted workflow sequence based on user features, with the predicted workflow sequence maximizing the reward metric for the user of the software application. The user features which may be input into the machine learning model may include static features associated with the user of the workflow and dynamic features associated with the user of the workflow. The static features may include, for example, features derived from a priori defined data associated with the user, such the size and age of an organization with which the user is associated. The dynamic features may include, for example, time-series data associated with user activity within the application, such as a search history, clickstream history, or the like.

In some aspects, the reward metric may be a cumulative reward metric calculated over each step in the predicted workflow sequence. The cumulative reward metric may be generated using a common reward value assigned to each step (or mini job) in the workflow. In some aspects, the cumulative reward metric may be generated using a unique reward value that is assigned to each respective step in the workflow. In some aspects, the reward metric may correspond to a predicted increase in a user metric assuming user completion of each step in the workflow, such as a predicted increase in revenue for the user's organization or the like.

At block 330, the operations 300 proceed with executing the generated workflow sequence.

### Example System for Generating and Rendering User Interfaces in Software Applications Using Machine Learning Models

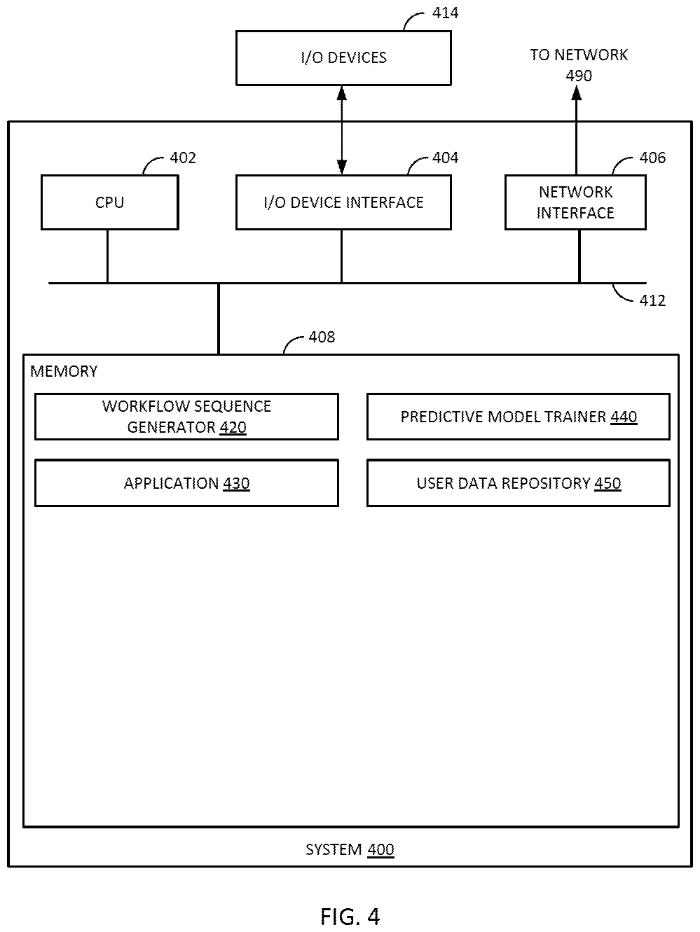

FIG. 4 illustrates an example system 400 in which user interface definitions are generated in response to receipt of an input query for data from a software application using machine learning models. System 400 may correspond to the application server 110 illustrated in FIG. 1. In some aspects, system 400 may perform the methods as described with respect to FIG. 2.

As shown, system 400 includes a central processing unit (CPU) 402, one or more I/O device interfaces 404 that may allow for the connection of various I/O devices 414 (e.g., keyboards, displays, mouse devices, pen input, etc.) to the system 400, network interface 406 through which system 400 is connected to network 490 (which may be a local network, an intranet, the internet, or any other group of computing devices communicatively connected to each other), a memory 408, and an interconnect 412.

CPU 402 may retrieve and execute programming instructions stored in the memory 408. Similarly, the CPU 402 may retrieve and store application data residing in the memory 408. The interconnect 412 transmits programming instructions and application data, among the CPU 402, I/O device interface 404, network interface 406, and memory 408.

CPU 402 is included to be representative of a single CPU, multiple CPUs, a single CPU having multiple processing cores, and the like.

Memory 408 is representative of a volatile memory, such as a random access memory, or a nonvolatile memory, such as nonvolatile random access memory, phase change random access memory, or the like. As shown, memory 408 includes a workflow sequence generator 420, an application 430, a predictive model trainer 440, and a user data repository 450.

Workflow sequence generator 420 generally corresponds to the workflow sequence generator 112 illustrated in FIG. 1. As discussed, the workflow sequence generator 420 may operate differently depending on whether a machine learning model that predicts optimal workflows to execute in the application 430 has been trained and deployed. If a machine learning model that predicts optimal workflows has not been trained and deployed, the workflow sequence generator 420 can randomly generate a workflow sequence for a requested workflow and instruct the application 430 to execute the randomly generated workflow sequence. If a machine learning model that predicts optimal workflows has been trained and deployed, the workflow sequence generator 420 can use the machine learning model to identify an optimal workflow for a user of the software application based on user features and a reward maximization strategy. The user features may include static features associated with the user or the user's organization and dynamic features associated with the user. These static features, in one example, may include features derived from a priori defined data associated with the user, such the size and age of an organization with which the user is associated, The dynamic features may include, for example, time-series data associated with user activity within the application, such as a search history, clickstream history, or the like.

Application 430 generally corresponds to the application 114 illustrated in FIG. 1. Generally, the application 114 presents a workflow sequence generated by the workflow sequence generator 420 to a user of the application (e.g., via transmission of a user interface defining the workflow sequence to a client device, such as the client device 120 illustrated in FIG. 1, via the network interface 406). During execution of the workflow, the application 430 captures user data which is committed to the user data repository 450 (which corresponds to the user data repository 130 illustrated in FIG. 1) for use in generating a training data set that can be used to train the machine learning models used by the workflow sequence generator 420 to identify a workflow sequence which results in the highest predicted reward metric value for the user of the application.

Predictive model trainer 440 generally corresponds to the predictive model trainer 116 illustrated in FIG. 1. The predictive model trainer 440 generally generates a training data set of user data and a workflow sequence presented to a user of the software application, mapped to a reward metric corresponding to a total reward obtained by the user assuming completion of the workflow. The predictive model trainer trains the machine learning model to be a prescriptive model using techniques such as uplift modeling techniques. After training the machine learning model, the predictive model trainer 440 deploys the machine learning model for use in predicting the optimal workflow to present to a user of the application 430.

Note that FIG. 4 is just one example of a system, and other systems including fewer, additional, or alternative components are possible consistent with this disclosure.

### Example Clauses

Implementation examples are described in the following numbered clauses:

Clause 1: A processor-implemented method, comprising: generating a plurality of sequences for a workflow, the workflow including a plurality of steps; deploying each respective sequence of the plurality of sequences for the workflow to a respective set of test users; calculating a reward metric for each respective sequence based on a performance metric for users who complete the workflow and a performance metric for users who abandon the workflow or have not executed the workflow; and training a machine learning model, based on a training data set including the plurality of sequences and the reward metric for each respective sequence, to predict an optimal workflow for a user, the machine learning model being trained to optimize the reward metric.

Clause 2: The method of Clause 1, wherein the plurality of sequences for the workflow includes a statically defined baseline sequence for the workflow.

Clause 3: The method of any of Clauses 1 or 2, wherein the training data set further includes one or more features associated with each user of the workflow.

Clause 4: The method of any of Clauses 1 through 3, wherein a number of users in the respective set of test users is based on a number of sequences in the plurality of sequences and a total number of test users participating in testing the workflow.

Clause 5: The method of any of Clauses 1 through 4, wherein calculating the reward metric comprises calculating a revenue difference between the users who complete the workflow and the users who abandon the workflow or have not executed the workflow.

Clause 6: The method of any of Clauses 1 through 5, wherein the reward metric comprises a difference between a performance metric for users who complete the workflow and a performance metric for users who abandon the workflow or have not executed the workflow.

Clause 7: The method of any of Clauses 1 through 6, wherein calculating the reward metric comprises calculating a cumulative reward metric for a user over multiple instances of executing the workflow.

Clause 8: The method of any of Clauses 1 through 7, wherein calculating the reward metric comprises calculating a metric based on a number of times a user completed the workflow.

Clause 9: The method of Clause 8, wherein calculating the reward metric comprises calculating the metric based further on a defined value associated with completing the workflow.

Clause 10: The method of any of Clauses 1 through 9, wherein generating the plurality of sequences for the workflow comprises generating one or more sequences including a set of steps including a number of steps less than a number of steps in the plurality of steps.

Clause 11: A processor-implemented method, comprising: receiving, from a user of a software application, a request to execute a workflow in the software application; generating, using a predictive model and features associated with the user of the software application, a workflow sequence that maximizes a reward metric for the user of the software application; and executing the generated workflow sequence.

Clause 12: The method of Clause 11, wherein the features associated with the user of the software application comprise at least one of static features defining characteristics of the user of the software application or dynamic features associated with user activity within the software application.

Clause 13: The method of any of Clauses 11 or 12, wherein the reward metric comprises a cumulative reward metric calculated over each step in the generated workflow sequence.

Clause 14: The method of any of Clauses 11 through 13, wherein the reward metric comprises a total revenue associated with completion of the workflow.

Clause 15: A system, comprising: a memory having executable instructions stored thereon; and a processor configured to execute the executable instructions to perform the methods of any one of Clauses 1 through 14.

Clause 16: A system, comprising: means for performing the methods of any one of Clauses 1 through 14.

Clause 17: A computer-readable medium having instructions stored thereon which, when executed by a processor, performs the methods of any one of Clauses 1 through 14.

### Additional Considerations

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processor-implemented method, comprising:
generating a plurality of sequences for a workflow, the workflow including a plurality of steps;
deploying each respective sequence of the plurality of sequences for the workflow to a respective set of test users;
calculating a reward metric for each respective sequence based on a performance metric for users who complete the workflow and a performance metric for users who abandon the workflow or have not executed the workflow; and
training a machine learning model, based on a training data set including the plurality of sequences and the reward metric for each respective sequence, to predict an optimal workflow for a user, the machine learning model being trained to optimize the reward metric.

2. The method of claim 1, wherein the plurality of sequences for the workflow includes a statically defined baseline sequence for the workflow.

3. The method of claim 1, wherein the training data set further includes one or more features associated with each user of the workflow.

4. The method of claim 1, wherein a number of users in the respective set of test users is based on a number of sequences in the plurality of sequences and a total number of test users participating in testing the workflow.

5. The method of claim 1, wherein calculating the reward metric comprises calculating a revenue difference between the users who complete the workflow and the users who abandon the workflow or have not executed the workflow.

6. The method of claim 1, wherein the reward metric comprises a difference between a performance metric for users who complete the workflow and a performance metric for users who abandon the workflow or have not executed the workflow.

7. The method of claim 1, wherein calculating the reward metric comprises calculating a cumulative reward metric for a user over multiple instances of executing the workflow.

8. The method of claim 1, wherein calculating the reward metric comprises calculating a metric based on a number of times a user completed the workflow.

9. The method of claim 8, wherein calculating the reward metric comprises calculating the metric based further on a defined value associated with completing the workflow.

10. The method of claim 1, wherein generating the plurality of sequences for the workflow comprises generating one or more sequences including a set of steps including a number of steps less than a number of steps in the plurality of steps.

11. A processor-implemented method, comprising:
receiving, from a user of a software application, a request to execute a workflow in the software application;
generating, using a predictive model and features associated with the user of the software application, a workflow sequence that maximizes a reward metric for the user of the software application; and
executing the generated workflow sequence.

12. The method of claim 11, wherein the features associated with the user of the software application comprise at least one of static features defining characteristics of the user of the software application or dynamic features associated with user activity within the software application.

13. The method of claim 11, wherein the reward metric comprises a cumulative reward metric calculated over each step in the generated workflow sequence.

14. The method of claim 11, wherein the reward metric comprises a total revenue associated with completion of the workflow.

15. A processing system, comprising:
at least one memory having executable instructions stored thereon; and
one or more processors configured to execute the executable instructions to cause the processing system to:
generate a plurality of sequences for a workflow, the workflow including a plurality of steps;
deploy each respective sequence of the plurality of sequences for the workflow to a respective set of test users;
calculate a reward metric for each respective sequence based on a performance metric for users who complete the workflow and a performance metric for users who abandon the workflow or have not executed the workflow; and
train a machine learning model, based on a training data set including the plurality of sequences and the reward metric for each respective sequence, to predict an optimal workflow for a user, the machine learning model being trained to optimize the reward metric.

16. The system of claim 15, wherein a number of users in the respective set of test users is based on a number of sequences in the plurality of sequences and a total number of test users participating in testing the workflow.

17. The system of claim 15, wherein to calculate the reward metric, the one or more processors are configured to cause the processing system to calculate a revenue difference between the users who complete the workflow and the users who abandon the workflow or have not executed the workflow.

18. The system of claim 15, wherein the reward metric comprises a difference between a performance metric for users who complete the workflow and a performance metric for users who abandon the workflow or have not executed the workflow.

19. The system of claim 15, wherein to calculate the reward metric, the one or more processors are configured to cause the processing system to calculate a cumulative reward metric for a user over multiple instances of executing the workflow.

20. The system of claim 15, wherein to generate the plurality of sequences for the workflow, the one or more processors are configured to cause the processing system to generate one or more sequences including a set of steps including a number of steps less than a number of steps in the plurality of steps.
